(19) United States
(12) Patent Application Publication
(10) Pub. No.: US 2005/0062713 A1
(43) Pub. Date: Mar. 24, 2005

(54) Power-saving method for video-broadcasting system in liquid crystal display (LCD) equipment

(76) Inventors: Hochao Huang, Shindian City (TW); Chee-Wen Shiah, Shindian City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/665,626

(22) Filed: Sep. 18, 2003

(51) Int. Cl. G09G 3/36

(52) U.S. Cl. 345/102

(57) ABSTRACT

A power-saving method for video-broadcasting system in liquid crystal display (LCD) equipment. The present invention utilizes programming to control the power supply of the back light source and the power supply of electrode plates, which can decrease the overall power consumption of LCD without affecting its video-broadcasting quality.

### BACKGROUND OF THE INVENTION

1. Field of Invention

The present invention relates to a power-saving method for a video-broadcasting system in liquid crystal display (LCD) equipment. More specifically, the present invention relates to a power-saving method for a video-broadcasting system in a twisted nematic LCD (TN-LCD), super-twisted nematic LCD (STN-LCD), and thin film transistor LCD (TFT-LCD).

2. Description of the Related Art

Liquid crystal displays (LCDs) are made by sealing liquid crystal (LC) material between two electrode plates, then coating orientation films on two electrode plates, and connecting a power supply to the two electrode plates. LC material exists in a state between the solid state and the liquid state. It not only flows easily due to external force like liquid but also possesses an anisotropic property like crystal, which in turn can be controlled by the application of a voltage across the LC material to change the arrangement of the LC material. Therefore, light changes its optical characteristics when passing through LC material. Since LC material cannot emit light, light perceived by humans is a reflection or refraction of a back light source.

LCDs can be classified according to the fabrication processes thereof into two kinds, namely the passive-matrix LCD (PM LCD) and the active-matrix LCD (AM LCD). The PM LCD is used in watches and portable calculators. However, the slow reaction speed of the PM LCD limits its application to television video. On the other hand, the AM LCD can drive a single pixel without affecting adjacent pixels, which achieves a good performance in color quality and reaction speed. The AM LCD is now widely used in notebooks and flat display equipment.

As for different product types, there are the twisted nematic LCD (TN-LCD), the super-twisted nematic LCD (STN-LCD), and the thin film transistor LCD (TFT-LCD).

The TN-LCD is a PM LCD. It has front and rear linear polarizers arranged parallel to one another. Moreover, the transmission axes of front and rear linear polarizers are perpendicular to one another. Without supplying voltage to the electrode plates, light passes through the front linear polarizer, then turns 90° with LC material, and passes through the rear linear polarizer. Once a voltage is applied to the electrode plates, light does not pass through the rear linear polarizer. Thus, when the power supply of the electrode plates is on, black color and white color are perceived. When the power supply of the electrode plates is on, there is no color.

The STN-LCD is also a PM LCD. The major difference between STN-LCD and TN-LCD is that light in an STN-LCD spins 180°, which increases video contrast. The background color of the STN-LCD is usually yellow or blue. In order to achieve full color, a color compensation plate is added to show black color and white color.

In recent years, the AM LCD has become increasingly popular. The AM LCD can be classified mainly as a diode structure or a transistor structure. Obviously, the TFT-LCD has a transistor structure, and basically uses a thin film transistor to set an address for each pixel. The thin film transistor is located at the intersection of the display column and the display row in the LCD and acts as a switch to turn on or turn off each single pixel. This is to say, the color filter is embedded in each pixel activated by each thin film transistor. By controlling the voltage of the thin film transistor, the LCD can have high contrast, fast reaction, and a wide viewing angle.

FIGS. 1A and 1B are diagrams showing how a TN-LCD works, which will be helpful to understand why light is emitted from LCD. The basic structure of the TN-LCD includes a front electrode plate 108, a rear electrode plate 116, a power supply of electrode plates 120, a front orientation film 110, a rear orientation film 114, a front polarizer 106, a rear polarizer 118, LC material 112, a back light source 102, which emits light 104, and a power supply of the back light source 100.

The front orientation film 110 is coated on the front electrode plate 108 and the rear electrode plate 116 is coated on the rear orientation film 114. The surface of the front orientation film 110 and the surface of the rear orientation film 114 both have thin ditches formed by rubbing. When LC material 112 is added between the front electrode plate 108 and the rear electrode plate 116, since LC material 112 flows easily, like a liquid, due to external force, it easily aligns itself along the thin ditches.

In places near the front orientation film 110 and the rear orientation film 114, LC material 112 is subjected to higher bonding forces and aligns exactly along the thin ditches. In the middle of two orientation films, the bonding force applied to LC material 112 is lower, which causes LC material 112 to turn gradually. LC material 112 turns 90° from the front orientation film 110 to the rear orientation film 114, and this kind of LCD is thus named TN-LCD.

Additionally, there are a front electrode plate 108 and a rear electrode plate 116 outside the front polarizer 106 and the rear polarizer 118.

When a light 102 emitted by the back light source 102 passes through the front polarizer 106, the light 102 is linearly polarized. When no power from the power supply of electrode plates 120 is applied, as illustrated in FIG. 1A, linearly polarized light enters LC material 112, and then gradually turns due to the arrangement of LC material 112. Since the transmission axis of the front polarizer 106 is parallel to the ditches of the front orientation film 110 and the transmission axis of the rear polarizer 118 is parallel to the ditches of the front orientation film 114, which means the transmission axis of the front polarizer 106 is perpendicular to the transmission axis of the rear polarizer 118, light 102 eventually passes through the rear polarizer 118 and is observed by humans.

On the other hand, when power is applied by the power supply of electrode plates 120, as illustrated in FIG. 1B, the LC material 112 aligns with the direction of the electric field applied so all LC material 112 is perpendicular to the front electrode plate 108 and the rear electrode plate 116. Therefore, linearly polarized light passes through LC material 112 and arrives in the rear polarizer 118. At this moment, the linearly polarized light is completely absorbed by the rear polarizer 118. Since no light passes through the rear polarizer 118, the effect is a dark area.

In conclusion, after carefully adjusting the power supply of electrode plates 120, the contrast effect of light and dark can be achieved.

Since light emitted from the LCD is not as bright as light emitted from cathode ray tube (CRT) display, the computer usually causes the back light source to emit more light. The main disadvantage of the above technique is the increase of overall power consumption. For a notebook with a portable battery, the time that the portable battery can be used decreases. Moreover, simply making the back light source emit more light deteriorates video quality.

### SUMMARY OF THE INVENTION

It is an object of the present invention to provide a power-saving method for a video-broadcasting system in liquid crystal display (LCD) equipment.

To achieve the above object, the present invention provides a programming method to control the power supply of the back light source and the power supply of electrode plates. As a result, brightness of the back light source is decreased. Further, brightness and contrast of video are increased. The programming method effectively cuts the power consumption of the power supplies and achieves power efficiency.

To achieve the above object, the present invention can be employed in a system containing an LCD and a portable battery, like a notebook. The present invention can decrease the overall power consumption of LCD without affecting the video quality thereof.

### BRIEF DESCRIPTION OF THE DRAWINGS

The drawings included herein provide a further understanding of the invention. A brief introduction of the drawings is as follows:

FIG. 1 shows a schematic diagram explaining how TN-LCD works;

FIG. 2 shows a block diagram of the present invention; and

FIG. 3 shows a flow chart of the present invention.

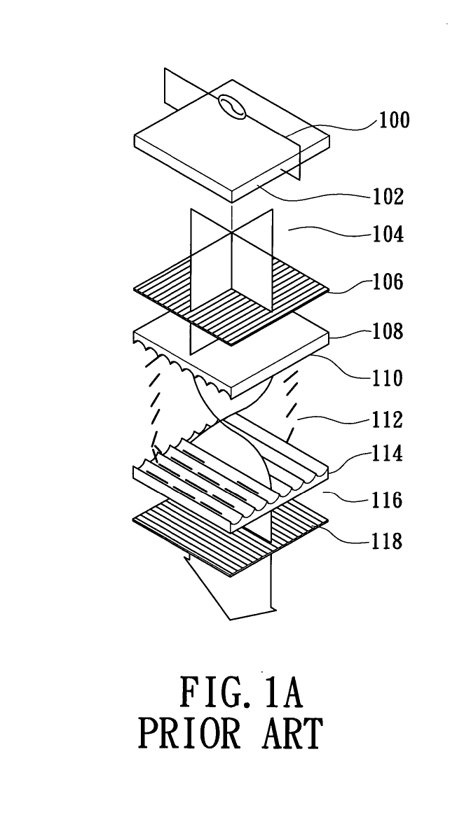

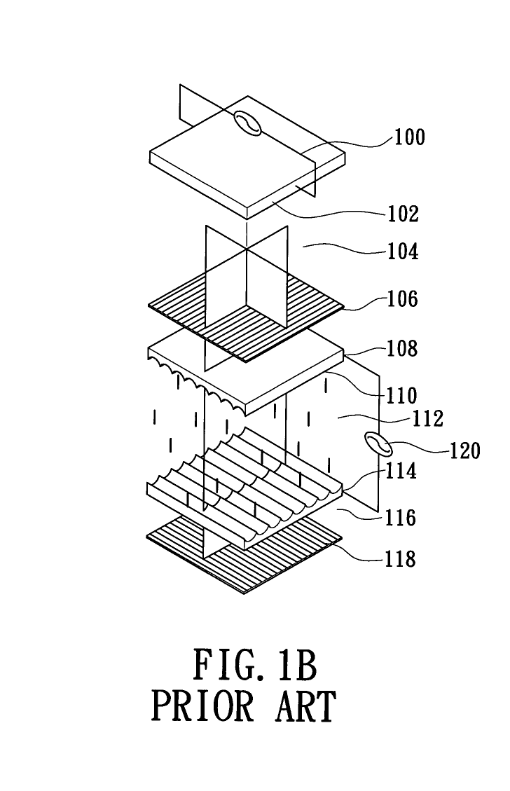

### DETAILED DESCRIPTION OF THE PREFERRED EMBODIMENT

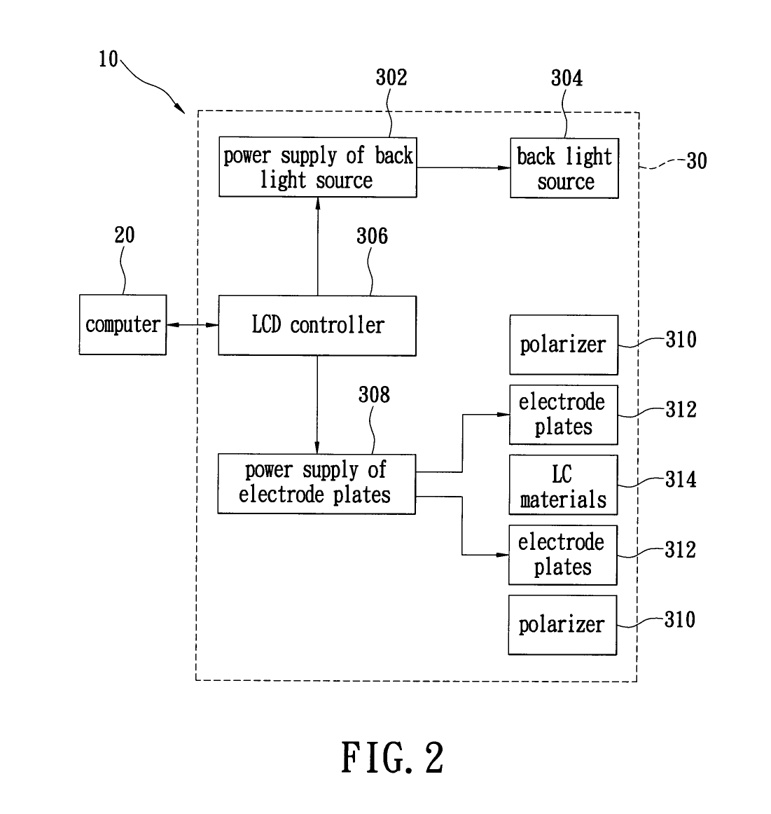

FIG. 2 shows a block diagram of the present invention. The LCD equipment mainly includes a computer 20 and an LCD 30. The computer 20 stores programs inside in order to control data, brightness and contrast of the LCD 30. The LCD 30 is composed of an LCD controller 306, a back light source 304, a power supply of the back light source 302, a pair of polarizers 310, a pair of electrode plates 312, a power supply of electrode plates 308, and a plurality of LC material 314.

To decrease the power consumption in the LCD 30, programs in the computer 20 send a command to decrease brightness of the back light source. After receiving the command, the LCD controller 306 sends information to the back light source 304, which eventually decreases power consumption in the power supply of the back light source 302. Undoubtedly, power saving is accomplished. However, brightness of the back light source is sacrificed. Consequently, the effect is power efficiency and the decrease of overall brightness.

At the same time, programs in the computer 20 adjust video information. Commands to increase brightness and contrast of video information are sent to the LCD controller 306, which in turn transmits video information to the power supply of electrode plates 308. When the power supply of electrode plates 308 is activated, the user sees no color. On the other hand, when the power supply of electrode plates 308 is turned off, the user sees the brightest color. As a result, increasing brightness and contrast of video information causes more light to be seen, less power to be used by the power supply of electrode plates 308, and more power to be saved. Accordingly, the effect is power efficiency and the increase of overall brightness.

The present invention combines the two effects mentioned above. Brightness of the back light source is decreased and brightness and contrast of video are increased. Therefore, power efficiency is achieved and overall brightness still remains, which can decrease the overall power consumption of LCD without affecting the video quality thereof.

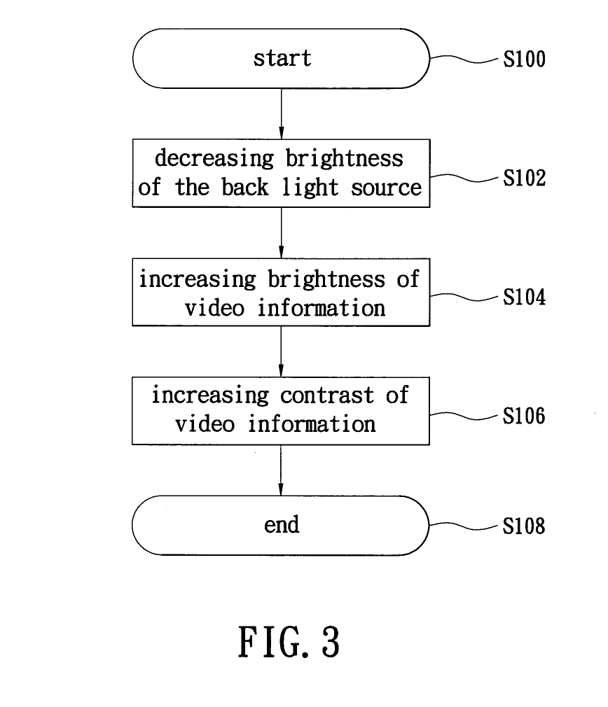

FIG. 3 shows a flow chart of the present invention. The method starts (S100). First, brightness of the back light source is decreased (S102), which saves power and decreases overall brightness. Then brightness of video information is increased (S104), and contrast of video information is increased (S106), which save more power and compensate for brightness loss in (S102). Finally, the method ends (S108). Video quality after adopting the present invention is almost the same as video quality without the present invention, and the overall power consumption in the LCD is decreased.

According to experimental results, when brightness of the back light source is decreased about 30%-70%, the more suitable value being 50%; brightness of video information is increased about 50%-100%, the more suitable value being 70%; and contrast of video information is increased about 70%-130%, the more suitable value being 100%; while video quality after adopting the present invention is almost the same as video quality without the present invention. If applying the present invention to a notebook with the LCD, the notebook will save almost 28% of power consumption.

Although the present invention has been described with reference to the preferred embodiment thereof, it will be understood that the invention is not limited to the details thereof. Various substitutions and modifications have suggested in the foregoing description; for example the LCD can be a TN-LCD, STN-LCD, TFT-LCD or other LCD with a similar structure, and others will occur to those of ordinary skill in the art. Therefore, all such substitutions and modifications intended to be embraced within the scope of the invention as defined in the appended claims.

1. A power-saving method for video-broadcasting system in liquid crystal display (LCD) equipment, wherein said liquid crystal display (LCD) equipment, such as, for example, a desktop, a notebook, or a PDA, includes a computer and an LCD, said power-saving method mainly comprising the steps of:
outputting a command about brightness of a back light source and a command about video information;
adjusting brightness of the back light according to the command about brightness of the back light source; and
adjusting video information according to the command about video information.

2. The power-saving method as in claim 1, wherein said adjusting brightness of the backlight decreases brightness of the back light.

3. The power-saving method as in claim 2, wherein said decreasing brightness of the back light decreases brightness of the back light by about 30%-70%.

4. The power-saving method as in claim 1, wherein said command about video information comprises the steps of:
adjusting brightness information in said video information; and
adjusting contrast information in said video information.

5. The power-saving method as in claim 4, wherein said adjusting brightness information increases brightness information.

6. The power-saving method as in claim 5, wherein said increasing brightness information increases brightness information by about 50%-100%

7. The power-saving method as in claim 4, wherein said adjusting brightness information increases contrast information.

8. The power-saving method as in claim 7, wherein said increasing contrast information increases contrast information by about 70%-130%.

9. The power-saving method as in claim 1, wherein said LCD is a TN-LCD, STN-LCD, or TFT-LCD.
